(19) United States
(12) Patent Application Publication
(10) Pub. No.: US 2014/0226956 A1
(43) Pub. Date: Aug. 14, 2014

(54) METHOD AND APPARATUS FOR CHANGING THE RECORDING OF DIGITAL CONTENT

(71) Applicants: Timothy Alan Barrett, Pymble (AU); Ben Crosby, Murphy, TX (US)

(72) Inventors: Timothy Alan Barrett, Pymble (AU); Ben Crosby, Murphy, TX (US)

(73) Assignee: THOMSON LICENSING, Issy de Moulineaux (FR)

(21) Appl. No.: 14/343,073

(22) PCT Filed: Sep. 12, 2011
(86) PCT No.: PCT/IB2011/002122

§ 371 Date: Mar. 6, 2014

(51) Int. Cl. H04N 9/79

(52) U.S. Cl. CPC H04N 9/79
USPC 386/292

(57) ABSTRACT

A method and apparatus for changing the recording of digital content are provided. The method (300) includes receiving (310) a data stream, recording (320) the stream, receiving (330) a notification identifying a change in at least a portion of the data stream, and outputting (370) a subset of the recorded data stream based on the notification. The apparatus (200) includes a receiver (202) that receives a data stream, a storage device (212) that records the stream, a controller (214) that creates a subset of the recorded stream based on a notification received by the signal receiver and identifying a change in at least a portion of the data stream, the notification received separate from the data stream, and a display interface (218) that outputs the subset of the recorded stream.

### TECHNICAL FIELD OF THE INVENTION

The present disclosure generally relates to digital content systems and digital video recording systems, and more particularly, to a method and device for changing or adjusting the recording of digital content.

### BACKGROUND OF THE INVENTION

When using a digital video recorder (DVR), it is common to record programs and to additionally schedule recordings of programs. Typically, when content is recorded on a DVR, it is stored as a simple, contiguous file. Some DVRs provide limited capability to manually edit the content or mark start and end points for deletion after the recording is complete, and this may be done by setting markers in the file, or by re-creating a new contiguous file with the deleted sections removed.

However, the timing of the delivery of program content for either manual or scheduled recording is sometimes affected by various events. In some cases, the timing is affected by the program itself, such as a sports program running over its allotted time period. In other cases, the timing is affected by pre-emption of portion of a program due to an emergency alert or special break-in content. Changes to the timing of the delivery of program content are often not easily accounted for, particularly in scheduled recording systems or any recording that is not monitored by the user. In some systems, a recording scheduler may monitor a program guide system to identify and account for timing changes. However, the changes in the program guide scheduler may often lag any immediate event change thus preventing sufficient notification to effect a change in the recording schedule.

Mechanisms to signal the DVR from the network that a program is running longer than expected, and, if the program is being recorded that it should continue until the real program end are not readily available or effective.

Additionally, the same problem exists with respect to the subsequent programs, such as whether these programs will also not follow the expected schedule or will be joined in progress. One potential mechanism to achieve a more timely notification mechanism involves including proprietary tags in the broadcast stream. Alternatively, a dedicated broadcast channel or stream may be transmitted along with the original content stream. Each of these mechanisms requires additional efforts from the broadcasting system and have not been used for reasons including cost and complexity. Therefore, there is a need for an improved mechanism for identifying adjusting the recording of content that is delivered over a broadcast network.

### SUMMARY

A method and apparatus for changing the recording of digital content are provided. In one embodiment, a method is described that includes receiving a data stream, the data stream containing at least one of audio data and video data, recording the data stream, receiving a notification identifying a change in at least a portion of the data stream, the notification received separate from the data stream, and outputting a subset of the recorded data stream based on the received notification.

In another embodiment, an apparatus is described that includes a signal receiver that receives a data stream, the data stream containing at least one of audio data and video data, a storage device, coupled to the signal receiver, the storage device recording the received data stream, a controller, coupled to the storage device and the signal receiver, the controller creating a subset of the recorded data stream based on a notification received by the signal receiver and identifying a change in at least a portion of the data stream, the notification received separate from the data stream, and a display interface, coupled to the controller and the storage device, the display interface outputting a subset of the recorded data stream.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is a block diagram of an exemplary system for delivering video content in accordance with the present disclosure;

FIG. 2 is a block diagram of an exemplary set-top box/digital video recorder in accordance with the present disclosure;

FIG. 3 is a flowchart of an exemplary method for adjusting the recording of content in accordance with the present disclosure;

FIG. 4 is a diagram illustrating an example of the recording adjustment process in accordance with the present disclosure;

FIG. 5 is a diagram illustrating another example of the recording adjustment process in accordance with the present disclosure.

It should be understood that the drawing(s) are for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present embodiments solve problems associated with how to have programs automatically recorded for an appropriate amount of time in a simple and relatively easy manner for the user. In particular, the embodiments solve the problem of recording programs that run over time to ensure full programs are recorded. A method and apparatus for changing the recording of digital video and audio content, particularly content broadcast to users in real-time, are provided. The embodiments are directed at the idea of dynamic video content trimming from a recorded program on a recordable medium, such a digital or personal video recorder. The process involves tagging portions, or scenes, of the recording content with start, end, and scene tags and/or providing relative timing markers that can be reconciled to the timing information delivered in scheduling messages. An automatic recorded content trimming process may also involve using identification information provided as part of the incoming received data, such as program start and end flags and scene flags, to further identify tagged content as well to dynamically remove content when the program stream is recorded. The tagged content can be identified and/or changed based on a trigger by a network type notification using a network other than the network that has provided the broadcast. Such a network may be an internet protocol (IP) based network and involve short messaging, such as Tweets (from a specific web based twitter account activated for the broadcast channel or the program). The tagged content is then used to modify recording schedules or trigger the trimming or removal of portions of the content. The removal may include physically deleting the content from the medium (e.g. hard drive) or may simply involve further tagging these scenes as not for use during playback of the program.

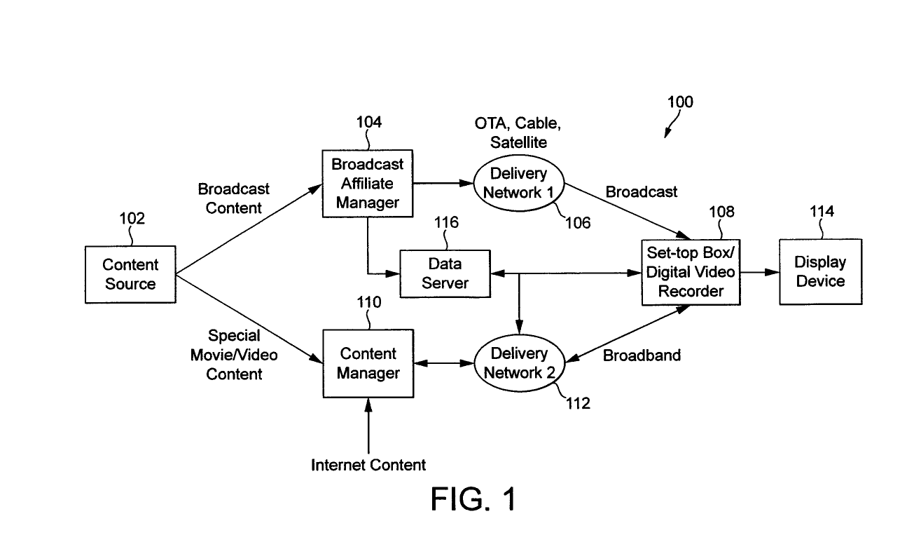

Turning now to FIG. 1, a block diagram of an embodiment of a system 100 for delivering video content to the home or end user is shown. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting Company (CBS), etc. The broadcast affiliate manager may collect and store the content, and may schedule delivery of the content over a deliver network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a user's set top box/digital video recorder 108 in a user's home. Broadcast affiliate manager 104 also provides information to data server 116. This information includes specific notifications regarding program schedule changes as a result program timing overruns or other program pre-emptions.

Additional information or content, such as special notices, scheduling information, or other content not provided to the broadcast affiliate manager may be delivered from content source 102 to a content manager 110. The content manager 110 may be a service provider, such as an Internet website, affiliated, for instance, with a content provider, broadcast service, or delivery network service. The content manager 110 may also incorporate Internet content into the delivery system. The content manager 110 may deliver the content to the user's set top box/digital video recorder 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of Delivery network 1 (106). In addition, the user may also obtain content directly from the Internet via delivery network 2 (112) without necessarily having the content managed by the content manager 110.

Data server 116 receives the information from broadcast affiliate manager and translates the information into a communications message suitable for delivery to a user device, such as settop box/digital video recorder 108. Data server 116 may include a web service for a web site, such as Twitter® or some other social networking site, having dedicated messaging capability, all of which are capable of delivering messages to users. Data server 116 may connect to delivery network 2 (112) to provide the communications messages to the settop box/digital video recorder 108. Alternatively, data server 116 may include a network interface to a cellular network or other wireless delivery network and provide communication messages in a format, such as short messaging services (SMS) directly to settop box/digital video recorder 108. Additionally, data server 116 may receive information from the internet through for instance, content manager 110 and delivery network 2 (112). The additional interface permits information related to programs, content, and scheduling to be provided to data server 116 from sources other than broadcast affiliate manager 104, such as other users or news agencies. In one embodiment, data server 116 creates a “User” account for each program or channel in the broadcast. Creating a “User” per channel or program and having a mechanism to dynamically generate text messages in a pre-defined format to indicate program status and start/end times provides a simple mechanism for clients or users to get parsable messages for each program relevant to it (i.e. each time there was a program being recorded or a scheduled recording, the would subscribe to that channel's or program's account).

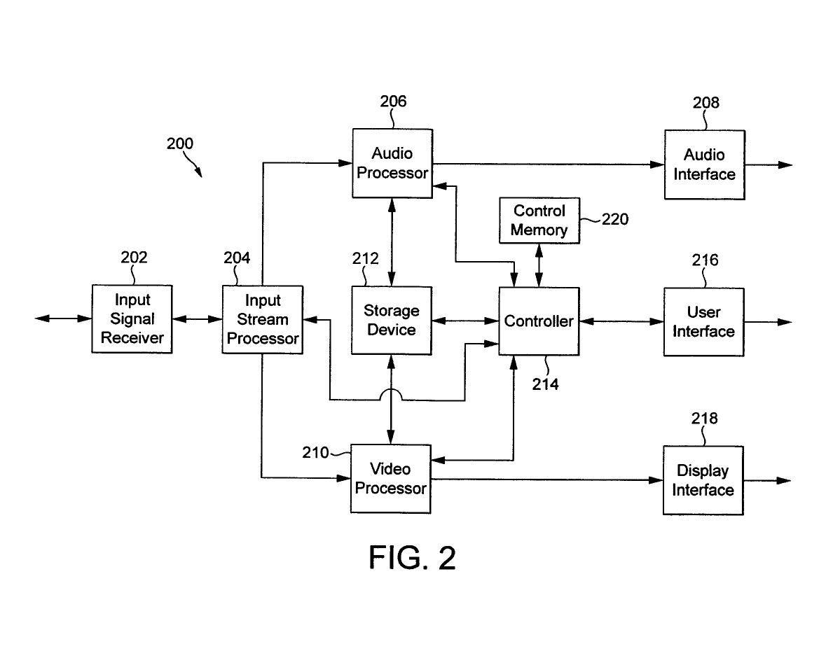

The set top box/digital video recorder 108 may receive different types of content from one or both of delivery network 1 and delivery network 2. The set top box/digital video recorder 108 processes the content, and provides a separation of the content based on user preferences and commands. The set top box/digital video recorder may also include a storage device, such as a hard drive or optical disk drive, for recording and playing back audio and video content. Further details of the operation of the set top box/digital video recorder 108 and features associated with recording content and playing back the stored content will be described below in relation to FIG. 2. The processed content is provided to a display device 114. The display device 114 may be a conventional two-dimensional (2-D) type display or may alternatively be an advanced three-dimensional (3-D) display.

It is important to note that any messages to indicate program status and start/end times or other scheduling information for programs may originate at a content source, such as content source 102, and be transmitted to a content manager and eventually delivered over delivery network 2 (112) to a client or user device, such as set-top box/digital video recorder 108. Alternatively, messages may be delivered to a data server, such as data server 116, re-formatted and then delivered to client or user devices. Still further, one or more messages may originate at the data server (e.g., data server 116) or at a third party source on the internet and provided to the data server for delivery to client or user devices.

Turning now to FIG.2, a block diagram of an embodiment of the core of a set top box/digital video recorder 200 is shown. The device 200 shown may also be incorporated into other systems including the display device 114 itself. In either case, several components necessary for complete operation of the system are not shown in the interest of conciseness, as they are well known to those skilled in the art.

In the device 200 shown in FIG. 2, the content is received in an input signal receiver 202. The input signal receiver 202 may be one of several known receiver circuits used for receiving, demodulation, and decoding signals provided over one of the several possible networks including over the air, cable, satellite, Ethernet, fiber and phone line networks. The desired broadcast input signal may be selected and retrieved in the input signal receiver 202 based on user input provided through a control interface (not shown). The decoded output signal is provided to an input stream processor 204. The input stream processor 204 performs the final signal selection and processing, and includes separation of video content from audio content for the content stream. The audio content is provided to an audio processor 206 for conversion from the received format, such as compressed digital signal, to an analog waveform signal. The analog waveform signal is provided to an audio interface 208 and further to the display device 114 or an audio amplifier (not shown). Alternatively, the audio interface 208 may provide a digital signal to an audio output device or display device using a High-Definition Multimedia Interface (HDMI) cable or alternate audio interface such as via a Sony/Philips Digital Interconnect Format (SPDIF). The audio processor 206 also performs any necessary conversion for the storage of the audio signals.

The video output from the input stream processor 204 is provided to a video processor 210. The video signal may be one of several formats. The video processor 210 provides, as necessary a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (Rew), received from a user interface 216. The storage device 212 may be a hard disk drive, one or more large capacity integrated electronic memories, such as static random access memory, or dynamic random access memory, an interchangeable optical disk storage system such as a compact disk drive or digital video disk drive, or storage external to, and accessible by, set top box/digital video recorder 200.

The converted video signal, from the video processor 210, either originating from the input or from the storage device 212, is provided to the display interface 218. The display interface 218 further provides the display signal to a display device of the type described above. The display interface 218 may be an analog signal interface such as red-green-blue (RGB) or may be a digital interface such as HDMI.

The controller 214 is interconnected via a bus to several of the components of the device 200, including the input stream processor 202, audio processor 206, video processor 210, storage device 212, and a user interface 216. The controller 214 manages the conversion process for converting the input stream signal into a signal for storage on the storage device or for display. The controller 214 also manages the retrieval and playback of stored content. The controller 214 is further coupled to control memory 220 (e.g., volatile or non-volatile memory, including random access memory, static RAM, dynamic RAM, read only memory, programmable ROM, flash memory, electronically programmable ROM (EPROM), electronically erasable programmable ROM (EEPROM), etc.) for storing information and instruction code for controller 214. Further, the implementation of the memory may include several possible embodiments, such as a single memory device or, alternatively, more than one memory circuit connected together to form a shared or common memory. Still further, the memory may be included with other circuitry, such as portions of bus communications circuitry, in a larger circuit.

It is important to note that input signal receiver 202 may also include receiving, demodulation, and decoding circuitry for data signals delivered over either the same delivery network as the desired broadcast input signal or over a different network, such as delivery network 2 (112) and/or an alternative cellular network as described in FIG. 1. The received data may be in the form of a social networking message, such as a tweet, or may be in the form of a short text message delivered over delivery network 2 (112) described in FIG. 1 or an SMS delivered over a cellular network. The received data may include information associated with scheduling changes and updates as well as information that is translated in controller 214 into commands for changing the recording schedule and operation in device 200.

In one embodiment, input signal receiver 202 in device 200 includes an internet protocol (IP) interface as well as bi-directional network connectivity. A social networking service, such as Twitter®, included as part of a social network may be provided independently of the broadcast signal. The social networking service provides short snippets (e.g., tweets) of information to followers of a particular user using standard web based technologies such as really simple syndication (RSS) and Atom. Device 200, through controller 214, joins a feed on the service and polls the server (e.g., data server 116 in FIG. 1) at a specific time interval, such as once every 10 seconds, to see if there have been any updates. Messages include structured extensible markup language (XML) that contain Program Name, estimated real world Start Time, End Time (e.g., real world End Time or offset from Start Time), and additional program data that could also enhance the consumer experience. Each new message may simply supersede the previous data. Device 200 may further be synchronized via an additional web service, such as network time protocol (NTP), allowing message timestamps to be extremely accurate.

Further, the web service may also support an open socket connection to reduce the load from each user device, such as device 200, to the data server, such as data server 116. As a result, information will only be sent as needed. Leveraging simple web technologies for messaging to clients providing information on program starts, ends and overruns would allow clients to easily determine when program recordings should be terminated in real time.

A method for changing or adjusting the recording of programs in a video recording device is described below. The physical implementation of the algorithm or function may be done in hardware, such as discrete circuitry related to the video processor 210, or software, such as software residing in the control memory 220 and read and execute by the controller 214. The method involves identifying content and, through the receipt of notification messages, adjusting recording times and analyzing the content to recognize and tag important points in the content that may represent the starts of scenes or other important reference points. Then, under a number of circumstances, the device 200 will be capable of automatically determining content that is not related to the desired content within the recorded content, based on several criteria. The analysis may be done prior to broadcast, on ingest to the device or at playback, though the preferred implementation is likely to be upon ingest to the device or when the content is written to disk.

One practical example of the present disclosure is to make it simple for a user to easily start viewing a recorded program at the correct new program starting point following a change to the scheduled start time. In this case, the right starting point, or playback position, would be based on information provided from a broadcast affiliate, such as broadcast affiliate manager 104 described in FIG. 1, or from another source, as well as any content tagging performed. When the play button is pressed, controller 214 will examine the tagged positions and make a determination of a scene positioned near an identified or estimated program start time. In the case of a “Black Reference Frame”, this could represent a significant marker (as black reference frames are used typically at the start and end of ad breaks), and if one is positioned near or at a program start time, then this may be used as the start point. Alternatively, reference frames outside the regular intervals could also be tagged as less significant trigger points, as they may also represent the start of a scene.

The method and apparatus of the present disclosure are predicated on having tags associated with the content so that when it is played back, information is available upon which to make a decision. This tag information could be obtained on one of three primary modes of operation. First, content could be pre-analyzed at the head end of the broadcast affiliate manager 104 or content manager 110, as described in FIG. 1, and have metadata broadcast along with it. This could be implemented by putting the tagging data as part of the service information (SI) data in the transport stream and sending the tagging data along with the content so there is no work at the DVR or device 200. Second, content could be analyzed and tagged as it flows in to the device 200 or as it is written to disk. Third, content could be analyzed dynamically upon playback and/or during trick mode operation so that reference points are created dynamically. For example, as a user fast-forwards or rewinds, the device is actually doing some frame analysis on either direction as the content is passing through. Each mode of tagging will now be further described.

In the first mode of tagging frames of the video content, tagging will be performed at the headend before the content is transmitted over a delivery network. Broadcasters are unlikely to support the tagging of content (particularly as it relates to the potential of skipping advertisements) due to the potential loss of revenue. However, the concept of actually having this capability at the encoder itself presents other opportunities, as there are also other implications of being able to have scene detection. If scene tagging existed in the stream itself, several possibilities emerge including, for example, tagging preferred commercials to indicate they can't be skipped. In a typical embodiment, the headend may not be relevant as the device 200 is likely to have a digital terrestrial tuner, so, like any other DVR, the device 200 is being fed content that it is processing on the fly. In an alternate embodiment, however, the headend may also be used to receive streamed, pre-prepared content. In this instance, using a similar solution, it may be an advantage to have some sort of enhanced scene detection within the film. For example, the broadcaster might want to have content having a very long group of pictures (GOP), with a high maximum intra-coded frame (I-frame) interval. In this instance, having tagging done at the headend may be of value and facilitate playback and searching through the content.

In the second mode of tagging frames of the video content, the tagging will occur during ingest to the set-top box/digital video recorder 200 by the video processor 210, that is, where the content is received and/or written to a disk, hard drive or other memory device. The point at which content is being ingested into the device and/or being processed and written to disk is likely to be the optimal point at which to analyze the content and provide tagging. The level of processing will vary depending on requirements, and be as simple as just tagging non-regularly spaced I-Frames, and “Black” I-frames or involve more sophisticated scene detection. There are considerations as to how much additional disk space can be used and much additional information should be stored. In one embodiment, when scenes are detected, thumbnails of the frame starting the scene may also be captured to allow a graphical based browsing of the content.

The third mode of tagging frames involves tagging content in real time. In the case where content is not pre-tagged, the video processor 210 can perform scene analysis where the scene analysis can be done on the fly during fast-forwarding and rewind events. In the event the user does a fast-forward or rewind, the video processor 210 essentially does the tagging on the fly, keeping counters as to where the appropriate scene points are. When the user presses play, the algorithms or functions described below will be applied to jump to the appropriate tag position.

In all cases, the tagging of content will be implemented as an automated solution that is completely invisible to the user, though there are potentially significant variations in how much information is tagged, what is used to determine those tags and how the tags are used. In one embodiment, the tags may constitute a very small amount of data that defines the key transition points in the file. For example, for a two-hour program which had six ad breaks, the start and end of those ad breaks could be defined by analyzing the scene changes where you have a black reference frame.

The process of detecting tag points in the video content will now be described. In the process of compressing video, an I-frame will typically be inserted every half a second or second, and there are a few interspersed I-frames that represent scene changes. As I-frames are typically spaced at regular intervals, in addition to the scene changes, one difficulty is that is a scene may change on a regular interval I-frame, making it difficult to identify as a new scene. It is relatively simple to calculate the actual maximum I-Frame interval of the content, as looking through a short history will reveal I-Frames at least every N frames. If, for example, the content has a maximum GOP size of ½ a second, there would be a minimum of 100 I-frames in every 50 seconds. However, due to additional I-Frames for scene changes, there may be, for example, 110 I-frames per 50 second period. From this we can still deduce the interval is roughly a value “X” or roughly half a second but there is additional I-frames in addition that represent scene changes.

The actual methodologies for detecting appropriate frames for tagging are relatively well known to those skilled in the art. For instance in a known approach, motion picture video content data is generally captured, stored, transmitted, processed, and output as a series of still images. Small frame-by-frame data content changes are perceived as motion when the output is directed to a viewer at sufficiently close time intervals. A large data content change between two adjacent frames is perceived as a scene change (e.g., a change from an indoor to an outdoor scene, a change in camera angle, an abrupt change in illumination within an image, and the like).

Encoding and compression processes take advantage of small frame-by-frame video content data changes to reduce the amount of data needed to store, transmit, and process video data content. The amount of data required to describe the changes is less than the amount of data required to describe the original still image. Under standards developed by the Moving Pictures Experts Group (MPEG), for example, a group of frames begins with an I-frame in which encoded video content data corresponds to visual attributes (e.g., luminance, chrominance) of the original still image. Subsequent frames in the group of frames, such as predictive coded frames (P-frames) and bi-directional coded frames (B-frames), are encoded based on changes from earlier frames in the group. New groups of frames, and thus new I-frames, are begun at regular time intervals to prevent, for instance, noise from inducing false video content data changes. New groups of frames, and thus new I-frames, are also begun at scene changes when the video content data changes are large because less data is required to describe a new still image than to describe the large changes between the adjacent still images. In other words, two pictures from different scenes have little correlation between them. Compression of the new picture into an I-frame is more efficient than using one picture to predict the other picture. Therefore, during content data encoding, it is important to identify scene changes between adjacent video content data frames.

The method and device of the present disclosure may detect scene change by using a Sum of Absolute Histogram Difference (SAND) and a Sum of Absolute Display Frame Difference (SADFD). Such methods use the temporal information in the same scene to smooth out variations and accurately detect scene changes. These methods can be used for both real-time (e.g., real-time video compression) and non-real-time (e.g., film post-production) applications.

In another embodiment of the present disclosure, there are several levels of tags, i.e., the tags are assigned a weight or priority. In this embodiment, the search zones within the content have more of an impact. Levels may, for example, be:
1) Blank Reference Frames (highest priority)
2) Non-Regular Reference frames (Secondary priority but represent scene changes)
3) Other (optional)

Typically, when playing back stored content, the playback would commence from a reference frame, though the tagging allows a better estimate of what frames the user is most likely to want to start from. If a priority 1 frame is found in the primary or secondary search zone, then playback will begin here. If a priority 1 frame is found in the primary zone, no further searching will take place. If there is no priority 1 tagged frame in the primary or secondary zones, the 2^{nd} priority tag closest to the center is selected for the start position. There may be “other” tags that need to be considered, as a tertiary priority in the same way as the priority 2 tags, though in the absence of any of these, the reference frame closest to the center of the primary search zone will be selected as the starting position.

The process of playing back the video content using tags or tagged frames will now be described. In one embodiment, in the case of video playback with pre-tagged content, assume that there is a content file on the disk or storage device 212 that has been tagged or a separate file that is associated with the content file that contains the tagging information. The tagging information will indicate the scene points generally within the video content file, and in particular would have weighted tags for how important these markers are as reference points. There are several possible tags types such as a defined “look-up point”, regular interval I-frame (reference frame), off-interval I-frame (representing a new scene), and also a blank I-frame. Blank (black) I-frames would have a very low data rate as they contain little data, and are generally inserted between ad-breaks, indicating transition from a commercial to the beginning of a scene or between scenes, for example.

In addition to the tagging and scene segment generation techniques described above, a time management system may be introduced in order to synchronize the delivered notification instructions to the recording content and, more importantly the tags and scene segments. In a digital content recorder, such as set top box/digital video recorder 200 described in FIG. 2, an internal clock is used to establish the schedule of the recording. The digital content recorder further establishes accurate time by either continually or periodically referencing a network time service (such as NTP), and as necessary, adjust or correct the local clock. As a result, the recording schedule, and the recording time of the content, may be synchronized to any incoming notifications and actions can be taken on the right portion of the content while the content is recording. It is important to note that several or more seconds of time inaccuracy between the local clock and a real world actual time global clock, as provided by a network time service, may be tolerated based on any synchronization error due to the use scene based detection. However, a few minutes of time drift, for example, would result in significant inaccuracy in determining the scene being referred to.

Once a program is recorded, several additional timing mechanisms may further be used to allow accurate trimming or adjustment of the recording content in conjunction with tagging and scene segmentation. First, accurate timing information may be included within the delivered content stream, such that a precise offset from a start time of either the recording or alternatively, the program itself, could be accessed. This timing information may be in the form of timestamps transmitted in the transport stream as part of the content.

Further, since the local clock in the digital content recorder is kept in relative synchronization with a global clock, whenever a recording is begun and ended, an accurate time and date of that recording will be recorded along with the content. In this way, any messaging notification delivered to the device regarding the trimming of content may be performed relative to that time. A time ordered database may also be maintained in the digital content recorder that includes the times (e.g., start time and end time) for each recording to allow rapid lookup of content based on the time it was broadcast.

Additionally, global timestamps may be generated by the digital content recorder, based on the local clock and the synchronization to a global clock. These global timestamps may be also recorded and stored with the content at periodic intervals as the content is being recorded. Alternatively, the global timestamps may be included in the scene tags during any subsequent tagging process following recording.

The timestamps may take several forms. Preferably, the timestamps would be in a format that is independent of any timezone conditions for the digital content recorder due to geographic location. These timezone independent timestamps prevent issues with timing errors as a result of a changed or incorrectly set timezone for the digital content recorder. The timestamp may, for example, be relative to a common timezone such as Greenwich mean time (GMT), that could apply to all devices regardless of location or timezone. Each device (e.g., digital content recorder) may easily convert the timestamp to a date relative to the device's current timezone for easy display and representation to a user by applying an appropriate offset. In one embodiment, the data format for a timestamp is YYDDMM:HHMMSS:XXX, where XXX represents milliseconds.

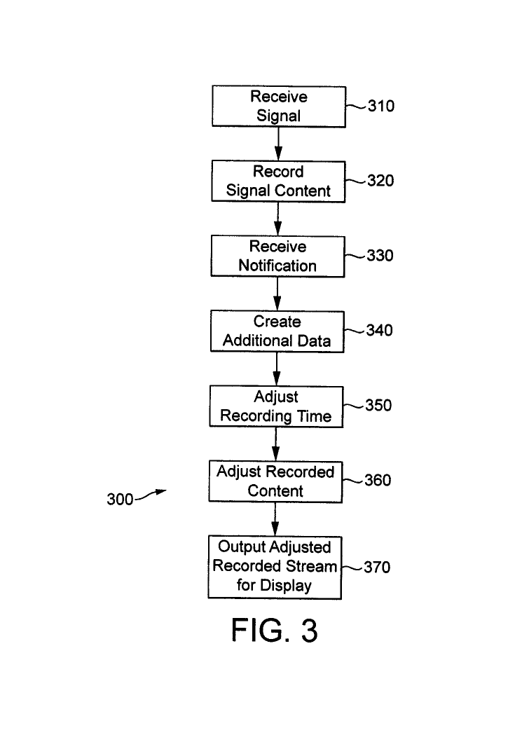

Turning now to FIG. 3, a flowchart of an exemplary embodiment of a process 300 for adjusting the recoding of content using aspects of the present disclosure is shown. The steps in process 300 will primarily be described with respect to the operation of set top box/digital video recorder 200 described in FIG. 2. However, some or all of the steps can be equally applied to the set top box/digital video recorder 108 in FIG. 1. Furthermore, it is understood that the steps in process 300 rely on communications delivered from a broadcast network source such as delivery network 1 (106) as well as from a secondary network, such as delivery network 2 (112), both described in FIG. 1. Further, it is important to note that some of the steps described in process 300 may be implemented more than once, or may be implemented recursively. Such modifications may be made without any effect to the overall aspects of process 300.

At step 310, a signal stream is received at the input of a settop box or other recording device, such as set top box/digital video recorder 200. The signal stream audio and/or video content provided from a broadcast signal source. Next, at step 320, the signal stream is recorded. The recording at step 320 may be initiated by a user manually, for instance, as a result of having to stop viewing the content but desiring to view it later. Alternatively, the recording at step 320 may be initiated based on a scheduled event. The scheduled event may have been scheduled by a user directly or may have been scheduled automatically based on user indications and preferences indicated and/or past recording schedules.

At step 330, during the recording at step 320, a notification related to the currently recorded program is received. The notification is received through a separate network, such as through an internet social networking web service, through a text messaging service over an IP or cellular phone network or the like. At step 340, the received notification is identified and the information in the notification is decoded. In one embodiment, set top box/digital video recorder 200 includes a command language translator capable of decoding portions of the transmitted message into control commands for controlling the operation of set top box/digital video recorder 200. More specifically, the command set sent as part of the notification may include one or more of a new recording starting or ending time, a continue recording until a stop command is issued, and a stop recording command. Further, the command set may include one or more timestamps (e.g., current time, original start time etc), a new start, or stop time for one or more programs, including the program currently being recorded or the program that has just recently ended. Each of these commands may be used in conjunction with adjusting the recording time of the program being recorded as well trimming the recorded content to delete or eliminate unwanted recorded content. As a result, each of these commands included in the notification creates additional data that is used during and after the recording of the program to adjust the current recording and/or modify recorded content.

Next, at step 350, based on the results from the identification of information in the notification and the creation of additional data related to the program at step 340, the recording time for the program currently being recorded is adjusted. The additional data may include information for continuing to record the current program past the original recording stop time, changing a recording start time to begin at a later start time, or stopping a recording that has been running past an original recording end time. It may also include start, end, and/or tag information for content that has been previously recorded. As a result, content already or previously recorded may, for instance, have start and/or end positions dynamically adjusted.

At step 360, following the completion of the recording that was started at step 320, and based on information received in the notification and the data created at step 340, the recorded content is adjusted or trimmed. This adjustment or trimming at step 360 may be done based on scene elements and tags that have been generated and inserted as described above, or may be done based on some form of time stamping applied to the recording itself.

It is important to note that the tagging of content and further the storing of scenes as separate elements, at step 360, allows the content to be identified and deleted from the recording. For example, if the program content is stored as separated elements, deleted scenes of content could be eliminated cleanly by being deleted and having the start and end references for the title updated. If the program content stored as a contiguous file, the eliminated elements could be removed by copying them as contiguous blocks to a new file when the system is idle after, for example, a user action to do so, after a certain period of time has passed, or when memory space on the recordable media is running low.

Alternatively, the tagging at step 360 allows content to be identified and skipped during playback, while still remaining as part of the recording. Further, trimmed content does not need to be physically detected, but rather the playlist or start point for the content simply is adjusted to remove those scenes that the user has removed. When additional storage space is needed, these detected scenes may be reclaimed by the system as available space, and the user may also potentially do a manual rebuild of the file to make it contiguous and therefore reduce the memory fragmentation.

Finally, at step 370, the adjusted recorded signal stream may be output to a display device. The outputting step 370 is typically performed as a result of a user request for playback and display of the content at some point after the recording is completed.

It is important to note that more than one notification may be received before, during, and/or after a recording event. As mentioned above, the steps in process 300 may be modified to include multiple occurrences, a re-ordering, or a recursive series of steps, depending on the specific notification requirements. The system may also automatically, where possible, include a large, potentially user-configurable buffer either side of a recording to ensure all the required content is captured. The simpler and more robust the notification is, and the easier it is to remove content elements, the more easily that a system may implement such an automatic buffering feature. In one embodiment, recording may be done in cache memory, such as RAM or flash memory, that temporarily stores the content in memory until the system has valid start and end markers, then this piece of the file could be transferred to the disk drive.

Additionally, some embodiments of process 300 may not include all of the steps as described and shown in FIG. 3 or may rearrange the order of the steps. In one embodiment, after the notification is received at step 330, the recording time of the current recording is adjusted, such as at step 350. The adjustment is based on information received in the notification, such as a change in the stop time of a program. An output signal is then provided using the adjusted recorded content, such as at step 370, based on the notification received and also on the adjusted recording time. Other embodiments related to process 300 are also possible.

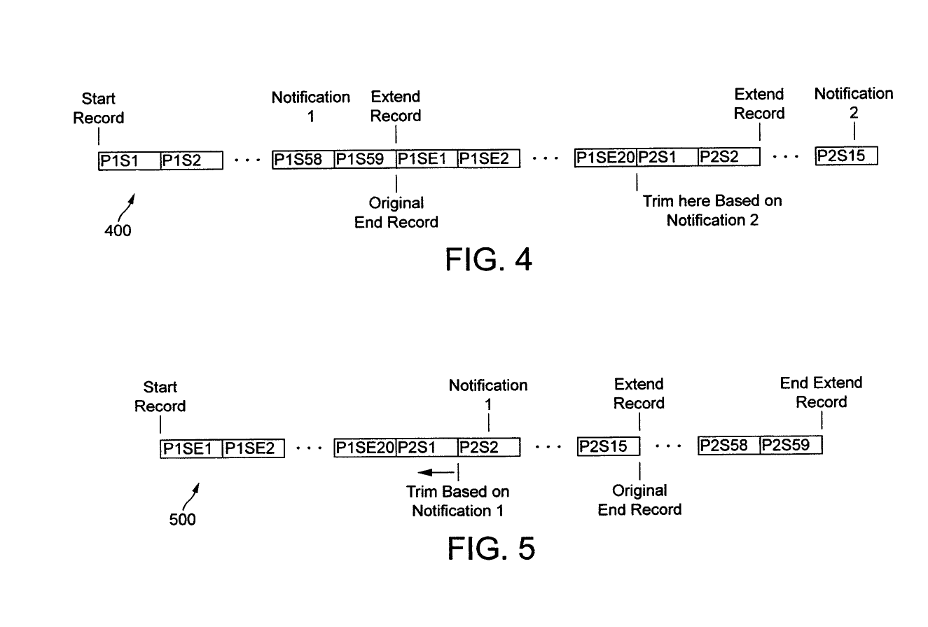

FIG. 4 illustrates an event diagram 400 identifying a set of events occurring during a scheduled recording of a program based on process 300 and including an additional notification. Diagram 400 includes a time point for recording begin followed by a series of recording segments for the first or desired program, P1S1 and so on. The recording segments may be time segments, tag identified segments based on scenes or GOPs as described, or any other possible recording segmentation system consistent with aspects of the present disclosure. At a point during recording of P1S58, a notification is received, as described at step 330 above. Following identification and data creation, the set top box/digital video recorder 200 is commanded to continue recording until a time 45 minutes after the original end recording time. As shown, the recording continues as shown by segments P1SE1 and so on. At a point before the 45 minute extension point is reached, the first program ends with P1SE20 and the next program begins as P2S1 and so on. The recording stops after 45 minutes at a point during recording of segment P2S2. Then, at some point after the recording of the first or desired program has ended, a second notification is received. In the second notification, information is included to identify that the first or desired program had ended 40 minutes after the originally scheduled ending time. The set top box/digital video recorder 200 uses this information to identify a point in the recorded content at or after P1SE20 and trims or deletes the remaining content (i.e. P1S1 and P1S2) from the recorded content. As a result, only the desired program content, including the content in the extended time period remains recorded and/or available for output to a display.

FIG. 5 illustrates another event diagram 500 identifying a set of events occurring during a scheduled recording of a program based on process 300. Diagram 500 includes a time point for recording begin based on an originally scheduled start time followed by a series of recording segments for an earlier program that is running past its scheduled start time, identified as P1SE1 and so on. As above, the recording segments may be time segments, tag identified segments based on scenes or GOPs as described, or any other possible recording segmentation system consistent with aspects of the present disclosure. At some point in time during recording, program 1 ends and program 2, the desired program begins, identified as P2S1 and so on. At a point during recording of P2S2, a notification is received, as described at step 330 above. Following identification and data creation, the set top box/digital video recorder 200 is commanded to continue recording until a time 45 minutes after the original end recording time. As shown, the recording continues as shown by segments P2S2 and past the original recording end time, shown as P2S15, to the new recording end time P2S59, the actual end time for the program. Following the completion of the recording, as described at step 360, the set top box/digital video recorder 200 uses the information provided in the notification to identify a point in the recorded content at or before P1SE20 and trims or deletes the remaining content (i.e. P1SE1,P1SE2 and so on) from the recorded content. As a result, only the desired program content remains recorded and/or is output for display.

The process and apparatus described above may also be used as a mechanism for editing or dynamically trimming content in a digital recording to simply cut out advertisements, or the program intro and closing content (e.g., theme introduction and closing credits). As with process 300, this process can also be made easy by the fact that estimated advertisement start and end positions and intro and ending portions may quickly be identified and/or estimated by the image scene start and end tags.

Further, with these scene tags available, a real time “Start Program” marker and an approximate timestamp for “End of Program” delivered from either the broadcast network (e.g., content delivery network 1 (106) in FIG. 1) or the alternative network (e.g., content delivery network 2 (112) in FIG. 2) can be reconciled with the segment or scene boundaries to determine the exact point at which a particular program actually starts and ends. If this is coupled with a mechanism on the device itself to have the content viewed as a playback list of a number of scenes either included or excluded (from playback and/or disk usage), then this allows the stored start and end of the program to be accurately represent what actually occurred. Because scenes and start/end points are identified, a long (and potentially user-configurable) overrun time may be recorded by default to ensure the end of any program is recorder, whether signaled or not, then this may be dynamically trimmed once the program end message is sent, or by a simple user scene based edit that indicates that all content after the selected point should be ignored.

The start and end data may also be broadcast as either a scene start tag and a counter for the number of “scenes” in the content (with each scene having a broadcast scene identification number), or simply be a timestamp or other general counter reconciled to a scene by the system. If, for example, as part of an automated “dynamic trimming process”, and assuming that the recording continued past the estimated end of the show, the user found that the content seemed to be cut short, they could add additional content to the playlist by either adding a certain amount of time, or by adding a scene at a time until the real end point of the content was reached.

In another embodiment, multiple playlists for the recorded content may also be provided or created. For instance, a playlist of what was originally recorded, a top and tail (intro and closing) playlist, and also potentially multiple different options of edited versions of the recorded content may be generated and/or provided. In this way, for example, if a program was made up of a series of music video clips, an edited playlist could edit out different sections of the video (i.e. different video clips) and potentially even re-order sections of content to make their own non-destructive playlist based on the content source. This embodiment would allow insertion of cut points, much as a traditional video editing system, and allow content to be dragged to different sections and re-ordered. Any playlist for a piece of content could be used as a base, or alternatively saved as a stand-alone content clip.

Further, scenes from other playlists/content could also be incorporated into a different piece of content. For example, a user that watches a lot of a particular program series of content could create a playlist for a recording that was just the start and credits of the program. The start and credits may then be trimmed or removed from all subsequent recordings of the program series, and a reference to this previously created clip into the subsequent recordings instead. As a result, only one copy of the start and close sequence of the series is required to be stored and in the recording memory (e.g., digital video recorder hard drive). The system and process may also include a feature to never delete any piece of content that is explicitly referenced in a playlist.

Although embodiments which incorporate the teachings of the present disclosure have been shown and described in detail herein, those skilled in the art can readily devise many other varied embodiments that still incorporate these teachings. Having described preferred embodiments of a method and device for optimal playback positioning in digital content (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method (300) comprising the steps of:
receiving (310) a data stream, the data stream containing at least one of audio data and video data;
recording (320) the data stream;
receiving (330) a notification identifying a change in at least a portion of the data stream, the notification received separate from the data stream; and
outputting (370) a subset of the recorded data stream based on the received notification.

2. The method (300) of claim 1, further comprising creating (340) additional data associated with the at least a portion of the data stream.

3. The method (300) of claim 2, wherein the additional data associated with at least a portion of the data stream is at least one tagged frame of content in the data stream.

4. The method (300) of claim 3, wherein the at least one tagged frame of the content is tagged before the outputting step.

5. The method (300) of claim 2, wherein the step of creating (340) additional data associated with at least a portion of the data stream further includes tagging at least one frame of content in the at least a portion of the data stream.

6. The method (300) of claim 5, wherein the step of outputting (370) the subset of the recorded data stream includes trimming the recorded data stream to produce the subset of the recorded data stream based on the tagging of at least one frame of content.

7. The method (300) of claim 1, further comprising adjusting (350) the recording of the data stream based on the received notification.

8. The method (300) of claim 1, wherein the notification is provided using a short messaging service.

9. The method (300) of claim 8, wherein the short messaging service is part of a social network associated with the data stream.

10. The method (300) of claim 1, wherein the notification is received from a source other than a source for the data stream.

11. The method (300) of claim 1, wherein the notification is based on the content of the data stream.

12. The method (300) of claim 11, wherein the data stream is a program that is broadcast to a plurality of users and the notification is based on at least one of the program start time has changed and program end time has changed.

13. The method (300) of claim 1, wherein the step of recording (320) the data stream includes recording time stamps associated with the data stream.

14. The method (300) of claim 13, wherein the notification includes at least one of a timestamp for a program, a new start time for a program, and a new stop time for a program.

15. The method (300) of claim 14, wherein the step of outputting (370) a subset of the recorded data stream includes identifying the subset of the recorded data based on a comparison of a timestamp provided in the notification to a timestamp in the recorded data stream.

16. An apparatus (200) comprising:
a signal receiver (202) that receives a data stream, the data stream containing at least one of audio data and video data;
a storage device (212), coupled to the signal receiver (202), the storage device (212) recording the received data stream;
a controller (214), coupled to the storage device (212) and the signal receiver (202), the controller (214) creating a subset of the recorded data stream based on a notification received by the signal receiver (202) and identifying a change in at least a portion of the data stream, the notification received separate from the data stream; and
a display interface (218), coupled to the controller (214) and the storage device (212), the display interface (218) outputting the subset of the recorded data stream.

17. The apparatus (200) of claim 16, wherein the controller (214) further creates additional data associated with at least a portion of the data stream.

18. The apparatus (200) of claim 17, wherein the additional data associated with at least a portion of the data stream is at least one tagged frame of content in the data stream.

19. The apparatus (200) of claim 18, wherein the controller (214) creates additional data associated with at least a portion of the data stream by tagging at least one frame of content in the at least a portion of the data stream.

20. The apparatus (200) of claim 19, wherein the subset of the recorded data stream includes the portion of recorded data stream identified by the tagging in the controller.

21. The apparatus (200) of claim 16, wherein the controller (214) further adjusts the recording of the received data based on the notification.

22. The apparatus (200) of claim 16, wherein the notification is provided using a short messaging service.

23. The apparatus (200) of claim 16, wherein the short messaging service is part of a social network associated with the data stream.

24. The apparatus (200) of claim 16, wherein the notification is received from a source other than a source for the data stream.

25. The apparatus (200) of claim 16, wherein the data stream is a program that is broadcast to a plurality of users and the notification is based on at least one of the program start time has changed and program end time has changed.

26. The apparatus (200) of claim 16, wherein the recorded data stream includes time stamps associated with the data stream.

27. The apparatus (200) of claim 26, wherein the notification includes at least one of a timestamp for a program, a new start time for a program, and a new stop time for a program.

28. The apparatus (200) of claim 27, wherein the controller (214) further identifies the subset of the recorded data stream based on a comparison of a timestamp provided in the notification to a timestamp in the recorded data stream.

29. An apparatus (200) for changing the recording of media content, the apparatus comprising:
means for receiving (202) a media stream, the media stream containing at least one of audio data and video data;
means for recording (212) the media stream;
means for receiving (202) a notification identifying a change in at least a portion of the media stream, the notification received separate from the media stream; and
means for outputting (218) a subset of the recorded media stream based on the received notification.
